(19) United States
(12) Patent Application Publication
(10) Pub. No.: US 2002/0112100 A1
(43) Pub. Date: Aug. 15, 2002

(54) System and method for data exchange

(76) Inventors: Myron Zimmerman, Needham, MA (US); Paul A. Blanco, Chelmsford, MA (US); Thomas Scott, Newton, MA (US)

Correspondence Address: Monica R. Gerber, Choate, Hall & Stewart, 53 State Street, Exchange Place, Boston, MA, 02109, US

(21) Appl. No.: 09/849,946

(22) Filed: May 4, 2001

Related U.S. Application Data
(63) Continuation-in-part of application No. 09/642,041, filed on Aug. 18, 2000.
(60) Provisional application No. 60/149,831, filed on Aug. 19, 1999.

(51) Int. Cl. G06F 3/00

(52) U.S. Cl. 710/1

(57) ABSTRACT

Using a lockless protocol, readers and writers exchange data of arbitrary size without using operating system services other than to initially establish a region of global shared memory. The readers and writers may be in interrupt context, process context and/or thread context. Multiple readers and writers are permitted, on the same or on separate processors sharing a global memory. Writers own a set of buffers in global shared memory. The buffers are re-used by their owner using an LRU algorithm. New data is made available to readers by atomically writing the buffer ID (and sequence number) of the most recently written buffer into a shared location. Readers use this shared location to find the most recently written data. If a reader does not have sufficient priority to read the data in the buffer before a writer must re-use the buffer for subsequent data, the reader restarts its read. Buffers contain sequence numbers maintained by the writers to allow the readers to detect this “slow read” situation and to restart its read using the most recently written buffer. Provisions are provided for data time stamps and for resolving ambiguity in the execution order of multiple writers that could cause time stamps to retrogress.

### CROSS-REFERENCE TO RELATED APPLICATIONS

This application is a continuation-in-part of U.S. application Ser. No. 09/642,041, filed Aug. 18, 2000, and claims benefit and priority of U.S. Provisional Application No. 60/149,831, filed Aug. 19, 1999, and of U.S. application Ser. No. 09/642,041, both of which are incorporated herein by reference.

### FIELD OF THE INVENTION

The present invention is related to data exchange between execution contexts, and in particular to a deterministic, lockless protocol for data exchange.

### BACKGROUND OF THE INVENTION

The exchange of data among processes within general purpose and real-time operating systems is a basic mechanism that is needed by all complex software applications, and various mechanisms are widely available. For simple data, that occupies no more than the native word length of the CPU, the exchange of data can be trivial, consisting of a mailbox that is written and read by single instructions. But for more complex data, which cannot be stored in a single word, the exchange of data is more complex, owing to the existence of races between reader and writer (or among multiple writers) that can cause the data read to be an inconsistent mixture of the data from multiple writes. The races come in two forms:

Between readers and writers running simultaneously on separate processors sharing the mailbox;

Between readers and writers running on the same processor but where one execution context is preempted (or interrupted) by the operating system and the other context is allowed to run.

In both cases, the corruption can be avoided by preventing more than one execution context from executing a region of code called the critical section. This is accomplished on uniprocessor systems by either 1) disabling preemption during critical sections; or by 2) allowing preemption of critical sections, detecting when another execution context tries to enter the preempted critical section and arranging for the critical section to be vacated before another execution context is allowed to enter. On multiprocessor systems, similar techniques are used to control preemption. In addition, simultaneous execution of a critical section by multiple processors is avoided ultimately by spin locks, which make use of special instructions provided by the processor.

Disabling preemption during a critical section is usually considered a privileged operation by many operating systems and may or may not be provided to some execution contexts as a service of the operating system. If provided as an operating system service, the overhead of calling the service is usually high when compared to the overhead in exchanging the data (at least for small data exchanges). Disabling preemption during a critical section also has the undesirable side effect on real-time systems of increasing the preemption latency. For large transfers, and therefore long critical sections, the increase in the maximum preemption latency can be substantial.

Allowing critical sections to be preempted but entered by only one execution context at a time is the preferred method on real-time systems, since this does not lead to increases in the maximum preemption latency. This technique requires operating system support, and is therefore dependent on the operating system in use. It also has the disadvantage of adding high overhead to exchanges of small amount of data, as already discussed.

Locks and critical sections are generally not robust with respect to application failures. If an execution context were to fail while holding the lock or critical section, other execution contexts would be denied access to the data. While recovery techniques exist, these techniques take time and are not compatible with time critical systems.

All of the above systems are lacking in one or more of the following desirable features:

Determinism. For execution environments that are deterministic, the reading and writing of data should be deterministic, without a possibility of a priority inversion requiring operating system intervention. Determinism allows a system to be used in real-time operating systems. Even in general-purpose operating systems, there may be contexts which need to be deterministic, such as interrupt service routines that interact within the timing constraints imposed by physical devices.

Operating System Independence. It is desirable to use as few operating system services as possible for data exchange to create the most portable system. Reducing the use of operating system services also minimizes overhead when exchanging small amounts of data. Further, an operating system independent system can be used for data exchange between execution environments that are running in different operating system environments on the same system (e.g., when a real-time operating system environment is added to a general-purpose operating system environment, or when data is exchanged between interrupt context and process context within a general-purpose operating system).

Robustness. The failure of a single reader or writer should not impair the performance of other readers and writers.

Fully preemptive/interruptible. Preemption and interrupts are preferably never disabled so latencies do not suffer as a consequence of exchanging data. Without fully preemptive data exchanges, severe scheduling latencies may occur with large exchanges.

Scales efficiently to a large number of concurrent readers.

Applicable to multiprocessor systems as well as uniprocessor systems.

### SUMMARY OF THE INVENTION

It is an object of the present invention to supply data exchange systems and methods that provide some or all of the above-mentioned features. A system according to the invention comprises various control structures manipulated by a lockless protocol to give unrestricted access to reading and writing data within shared buffers. The various control structures and pool of shared buffers implement a data channel between readers and writers. More than one data channel can exist, and these data channels can be named. The data written to the data channel can be arbitrarily large, although an upper bound must be known prior to use so that buffers may be pre-allocated, avoiding the indeterminism and operating system involvement of dynamic buffer allocation during the exchange of data. Readers and writers of the data channel are never blocked by the system of the invention.

The buffers contain data written at various times. When a reader requests access to data, it is given access to the buffer containing the most recent data at the time of the request. After the reader accesses the data within the buffer, the reader dismisses the buffer. Since writers are not blocked and the pool of buffers is finite, the buffer accessed by the reader may have been reused by a writer and overwritten with more recent data. This case is detectable by the reader at the time of dismissal and it is then up to the reader to repeat the read access to obtain new data.

Each writer has its own pool of buffers. These buffers are in memory shared with processes that are reading the data. Buffers may be reused for writing in least recently used (LRU) order to maximize the time available for a reader to complete its access to the data in a buffer before the writer that owns the buffer must reuse it for a subsequent write. When a writer requests a buffer to write, it may be given the LRU buffer from its pool of buffers. After the writer writes the data into the buffer, the writer releases the buffer. Once the writer successfully releases the buffer, it becomes the buffer with the most recent data that is available to readers. Alternatively, other algorithms for reusing buffers for writing may be used.

At any moment in time, several versions of the data may exist in buffers and each buffer may be in the process of being read by zero, one, or more readers. There is, however, always a most recently written buffer that is maintained by the invention. The availability of more recently written data is not necessarily cause for readers to abort their access to the buffer that they started to read. It is only when a writer must reuse one of its buffers that the readers of that buffer must restart.

An optional timestamp can be specified at the time that a write buffer is released. In such embodiments, the timestamp is available to readers of the buffer and the invention guarantees that timestamps will never decrease even when multiple processes are writing a data channel. If a writer does not have sufficient processor priority to dismiss its buffer before another writer with a later timestamp succeeds in dismissing its buffer, the buffer with the earlier timestamp is ignored so as to preserve time ordering.

### BRIEF DESCRIPTION OF THE DRAWING

The invention is described with reference to the several figures of the drawing, in which,

FIG. 1 is a block diagram showing the various execution contexts (readers and writers) within a computer system that may use the invention to exchange data;

FIG. 2 is a block diagram of the data structures shared among readers and writers;

FIG. 3 is a flow chart describing the use of the invention by an execution context that is reading a data channel;

FIG. 4 is a flow chart describing the use of the invention by an execution context that is writing a data channel;

FIG. 5 is a block diagram of data structures maintained by writers for managing the reuse of buffers for one particular embodiment of the invention; and

FIG. 6 is a flow chart describing the algorithm for managing the reuse of buffers for one particular embodiment of the invention.

### DETAILED DESCRIPTION

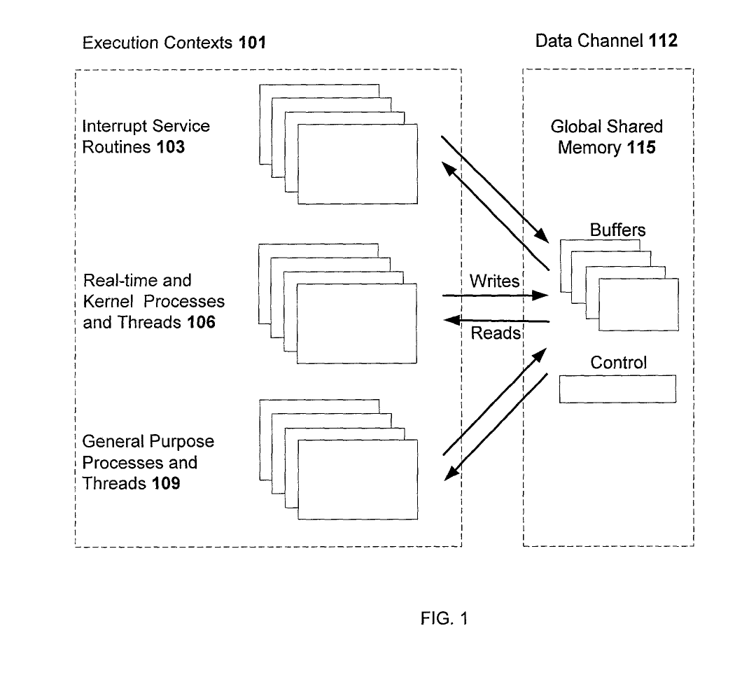

FIG. 1 depicts the various execution contexts 101 within a computer system that may use the invention to exchange data. The invention does not make use of operating system services to exchange data and assumes that preemption and/or interruption can occur at anytime, so an execution context may be an interrupt service routine 103 or a privileged real-time/kernel thread/process 106 or a general-purpose thread/process 109. The execution contexts may reside on a single processor or may be distributed among the processors of a multiprocessor with a global memory shared among the processors. If used on a multiprocessor system, execution contexts may freely migrate among the processors as is supported by some multiprocessor operating systems.

The exchange of data is through buffers allocated in global shared memory 115 along with control structures used by the invention. The portion of global shared memory used by the invention is mapped into the address space of the execution contexts. The allocation of global shared memory and the mapping of this memory into the address space of the execution contexts is operating system dependent and typically is not deterministic. The embodiment of the invention on a particular operating system would make use of whatever API that is provided for this purpose and perform the allocation and mapping prior to the exchange of data so that the exchange of data is deterministic.

For the purposes of explaining the invention, execution contexts are categorized as either readers or writers. In practice, an execution context can be both a reader and a writer. An execution context that will write data is assigned a pool of buffers to manage in global shared memory. The number of buffers assigned to a writer is a configurable of the invention.

The invention implements a data channel 112 in software for the exchange of data. Upon a request for read access, a reader is given access to the buffer in global shared memory that contains the most recently written data at the time of the request. The reader may access the buffer provided to the reader for an unbounded length of time. But the reader cannot make any assumptions about the consistency of the buffer until read access to the buffer is relinquished and consequently a check is made to be sure the buffer was not reused by a subsequent write during the interval that read access was taking place. If upon relinquishing read access the reader determines that a writer has reused the buffer, the reader repeats its request for read access.

The reader should not modify a buffer provided for read access. In a preferred embodiment of the invention, providing readers with read-only mapping of the control structures and buffer pool can enforce this.

Upon receiving a request for a write buffer, in certain embodiments of the invention a writer is given access to the least recently used buffer from the writer's own pool of buffers residing in global shared memory. The writer may change the buffer in whatever fashion desired. Once the buffer has been updated, write access to the buffer is relinquished and the buffer subsequently becomes available to readers as the most recently written data, unless more current data, as determined from time stamps associated with the data, is already available to readers. If the buffer is associated with a numerically smaller time stamp than what is already available to readers, the write to the data channel is ignored (i.e., the contents of the buffer is changed, but the buffer is not made available to readers). Writers of the data channel are never blocked. In certain embodiments of the invention, rather than giving the writer access to the least recently used buffer from its own pool of buffers, other algorithms for reusing buffers for writing may be employed, provided the buffer given to a writer upon the writer's request for a buffer is not the most recently written buffer from that writer's assigned pool of buffers.

While a buffer is the most recently written buffer, writers are not permitted to change its data. Subsequent writes to the data channel are accomplished by modifying the contents of other buffers from the pool of buffers and then designating these buffers, in turn, as the most recently written buffer. Simply requiring the pool of buffers assigned to each writer to contain at least two buffers enforces this.

No restriction is placed on the data that is exchanged, other than that it fit in the buffers that are allocated from global shared memory. Writers may specify a time stamp to be associated with the data written. The interpretation of the time stamp is left as a contract between readers and writers of the data but must never retrogress in its numerical value.

In one embodiment of the invention, an Application Programming Interface (API) provides the ability to read and write to the data channel. This API may have a binding to the various programming languages that are in common use. The API of an illustrative embodiment of the invention is depicted in Table 1.

TABLE 1

| API | Description |
|---|---|
| OpenForWriting | Identify the caller as a writer of the data |
| | channel and perform initializations. |
| AcquireBufferForWriting | Return a reference to a buffer to be filled |
| | with new data to be written to the data |
| | channel. |
| ReleaseWrittenBuffer | Release the buffer, making the buffer |
| | available to readers as the last written buffer. |
| CloseForWriting | Disassociate the caller as a writer to the data |
| | channel. |
| OpenForReading | Identify the caller as a reader of the data |
| | channel and perform initializations. |
| AccessBufferForReading | Return a reference to the buffer that has the |
| | latest data written to the data channel. |
| DismissBufferForReading | Relinquish read access to the buffer and |
| | determine if the data in the buffer has |
| | changed during access. |
| CloseForReading | Disassociate the caller as a reader of the data |
| | channel. |

Table 2 shows data types that are relevant to the invention.

TABLE 2

| Type | Description |
|---|---|
| seq_t | A value, preferably 32-bit or larger, that is used to version a |
| | data structure associated with it |
| time_t | A timestamp, with whatever granularity of time required by |
| | the application. |
| buffer_t | A buffer containing control structures specific to the |
| | invention and the application data read from and written to |
| | the data channel. |

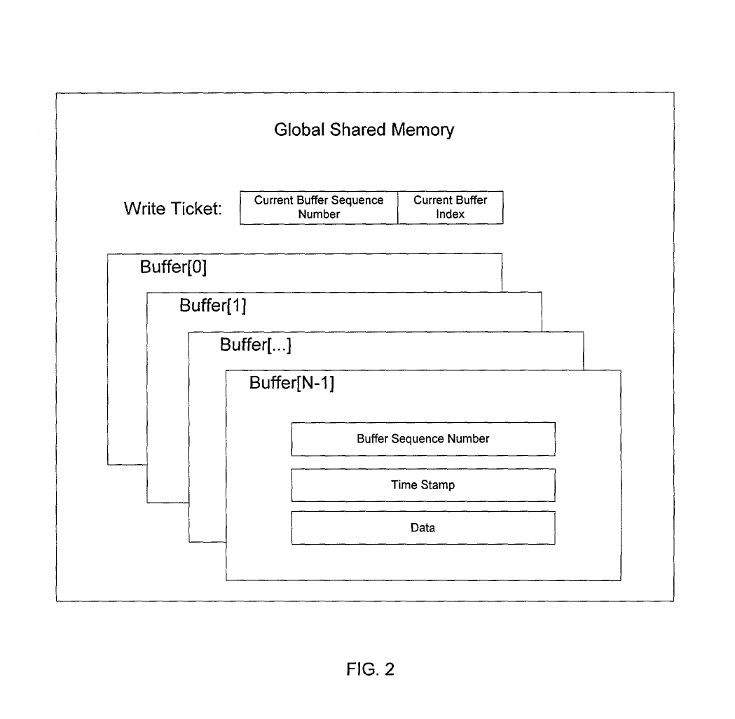

FIG. 2 is a block diagram of the data structures shared among readers and writers for the purpose of implementing a data channel. Only a single data channel is illustrated in the examples described below, but those skilled in the art will recognize that multiple data channels can be created. A data channel is composed of the data structures of Table 3, which reside in global shared memory:

TABLE 3

| Variable | Type | Description |
|---|---|---|
| Buffer[] | Array of buffer_t | A pool of N buffers used for the |
| | (See text). | exchange of data. |
| Write Ticket | seq_t | Encodes the buffer index of the most |
| | | recently written buffer and the value of |
| | | the buffer sequence number of the |
| | | most recently written buffer. |

A buffer index, an integer from 0 . . . N-1, identifies each buffer within the buffer pool. These N buffers are partitioned among the M writers to the data channel. In certain preferred embodiments of the invention each writer to the data channel manages its own subset of the buffer pool in a LRU fashion. The LRU algorithm may use locks without compromising robustness since failure of the writer does not jeopardize the ability of other readers or writers in the system. Writers need not be provided with the same number of buffers from the pool.

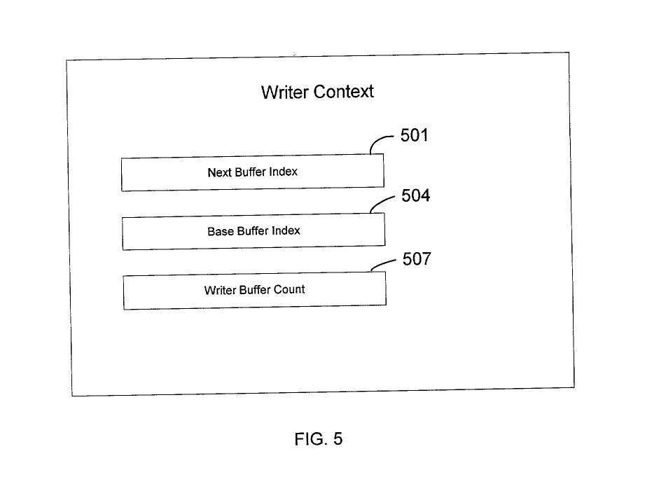

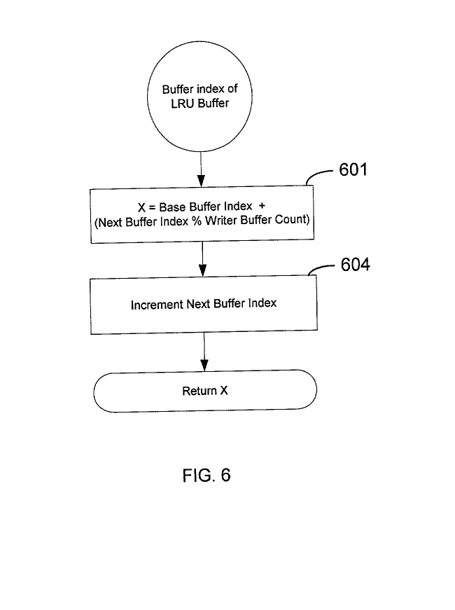

The initial allocation of buffers in global memory and the assignment of buffers to writers are illustrated in the following example of an embodiment of the invention. In this example, readers and writers are processes. Prior to or upon running the first process that may read or write the data channel, the Write Ticket and pool of N buffers are allocated from global shared memory. From this global pool, mutually exclusive subsets of the pool will be assigned to each writer. Processes indicate their intention to write to the data channel by calling the OpenForWriting API, passing a count of buffers to claim from the pool of N buffers. The OpenForWriting API will allocate the data structures of FIG. 5 in process private memory. If there are enough unassigned buffers in shared memory to satisfy the request, the requested number of unassigned buffers are assigned to the writer. The simplest approach is to make such assignments as a consecutive sequence of buffer IDs. The first buffer ID of the sequence is stored in Base Buffer Index and the length of the sequence is stored in Write Buffer Count. The caller of the OpenForWriting API now has write ownership of the buffers of the sequence until the process calls the CloseForWriting API or the process exits. The AcquireBufferForWriting API uses Next Buffer Index to cycle buffer IDs in LRU fashion from the sequence of buffer IDs defined by Base Buffer Index and Write Buffer Count. FIG. 6 depicts an algorithm to be used by AcquireBufferForWriting to pick a buffer for reuse.

In this particular example, the write buffers are assigned to writing processes and not to writing threads (that is the execution context is a process and not a thread). Consequently, it is not valid for multiple threads within the same process to be writing simultaneously to the data channel. This can be enforced by the AcquireBufferForWriting API, which can return an error if a buffer ID is already outstanding. A buffer ID is outstanding from the time that it is returned by AcquireBufferForWriting until the ReleaseWrittenBuffer API is called.

Bits within the Write Ticket encode both the buffer index of the most recently written buffer and the value of the sequence number of the most recently written buffer. Various methods of encoding may be used. An illustrative embodiment of the invention is provided as follows. Given T as the value of the Write Ticket, N as the number of buffers within the buffer pool, B as the buffer index of the last write to the data channel and S as the value of the sequence number of the last write to buffer B, the following relationships hold:

B = T % N
S = T/N
T = S * N + B

Each buffer in the buffer pool comprises the elements listed in Table 4.

TABLE 4

| Member | Type | Description |
|---|---|---|
| Buffer | seq_t | A sequence number incremented by each |
| Sequence | | writer before writing to the buffer. |
| Number | | |
| Time Stamp | time_t | An application-supplied timestamp |
| | | associated with the data written to the buffer. |
| Data | Application | The data that has been written to the buffer. |
| | defined. | |

The Buffer Sequence Number for the buffer is incremented when write access to a buffer is provided. (As used herein, “incremented” need not mean simply adding 1 to a value, but comprises any change to the value). The Buffer Sequence Number is used to determine if Data and Time Stamp have changed since read access to a buffer has been provided. Upon providing read access, the value of Buffer Sequence Number is decoded from the Write Ticket and stored by each reader. After reading the buffer, the current value of the Buffer Sequence Number is compared with the value that was provided with the read access. If there is a mismatch, the integrity of the data read is in question and the reader must repeat its request for the most recently written buffer. On uniprocessor systems, a repeated read can only take place if a writer to the same data channel preempts/interrupts the reader. The effect of the repeated read on performance can be viewed as a lengthening of the effective context switch/interrupt service time. This allows the invention to be used with existing real-time scheduling theories that account for the latency to switch contexts.

The interpretation of Time Stamp is application defined. It may represent the time that the data was acquired, the time that the data was written to the data channel or may be an expiration date beyond which time the data is invalid. Applications not using time stamps can effectively disable this aspect of the invention by setting Time Stamp to 0 for all writes.

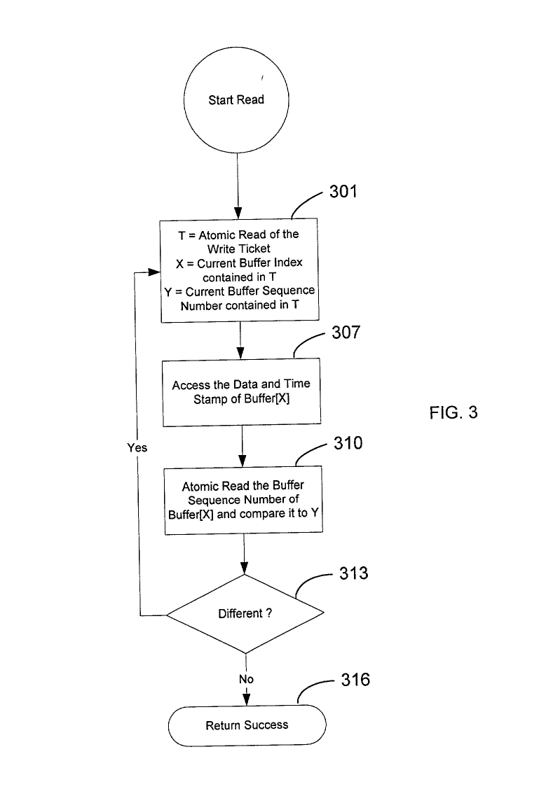

FIG. 3 is a flow chart describing the use of the invention by an execution context that is reading a data channel. The most recently written buffer is determined by reading the Write Ticket 301. The Current Buffer Index, which is the index of the most recently written buffer, is encoded in the Write Ticket along with the Current Buffer Sequence Number, which is the sequence number of the most recently written buffer at the time that it was written. The bits encoding the Current Buffer Index and Current Buffer Sequence Number may straddle word boundaries, so the Write Ticket must be read atomically (i.e., as an uninterruptible operation) to insure its integrity in the presence of preemption or simultaneous access by multiple processors.

The reader can now access the data and timestamp 307. The data within the buffer can be read but the reader should not act upon the data until the Buffer Sequence Number is checked to be sure that its value has not changed 310, indicating that a writer has reused the buffer. If the Buffer Sequence Number has changed from underneath the reader 313, the reader repeats—reading the Write Ticket again to determine the new most recently written buffer (and buffer sequence number).

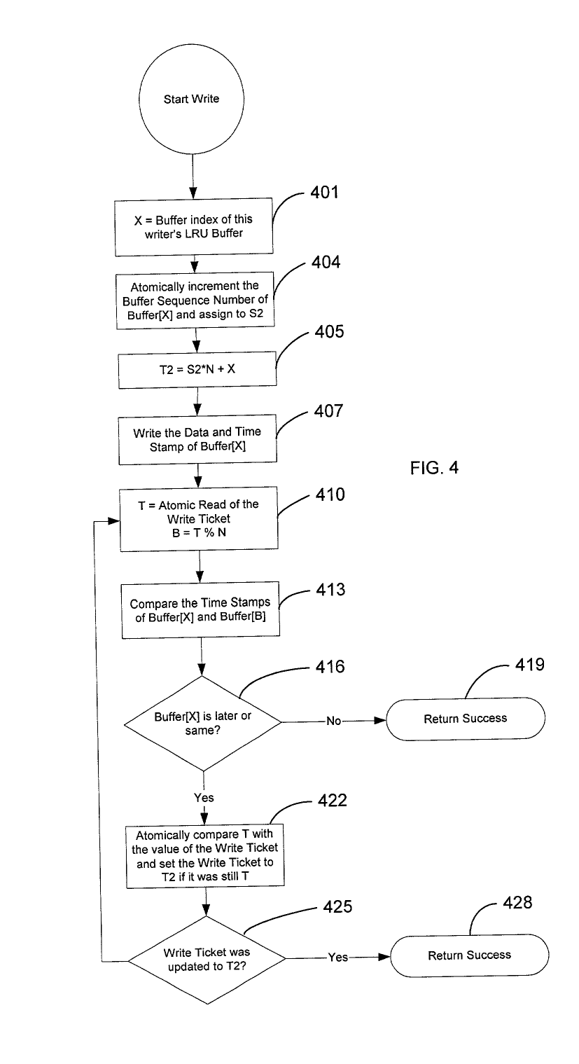

FIG. 4 is a flow chart describing the use of the invention by an execution context that is writing a data channel. The least recently used buffer from the writer's pool of buffers is picked for reuse 401. The LRU algorithm provides maximum opportunity for slow readers to read the data before a writer must reuse a buffer however, as discussed above, other algorithms may be used. Prior to changing the data in the buffer, the writer increments the Buffer Sequence Number within the buffer 404 and creates a new value for the Write Ticket. Buffer Sequence Numbers must be atomically modified and read to insure integrity in the presence of preemption or simultaneous access by multiple processors.

The new value, T2, for the Write Ticket is constructed from the Buffer Index and the Buffer Sequence Number 405. The combination of Buffer Index and Buffer Sequence Number will be used to uniquely describe the new state of the data channel as a consequence of the write.

Once the Buffer Sequence Number is incremented, the writer modifies the Data and Time Stamp within the buffer 407. The buffer is now ready to be released to readers. To release the buffer, the Write Ticket is read to determine the Current Buffer Index 410. The Time Stamp of the new buffer is then compared with the current buffer 413. If the new buffer has an earlier Time Stamp, the new buffer is assumed to be late and is silently rejected 419. If the new buffer has a later (or same) Time Stamp, the writer attempts to update the value of the Ticket to reflect the new Current Buffer Index and new Buffer Sequence Number 422. The update must be done atomically since another writer may be updating the Write Ticket simultaneously. The update is easily implemented as a Compare and Swap operation, which is implemented as an instruction on most processor architectures. If the update is successful, the writer returns 428. Otherwise, the writer must repeat its update of the Ticket.

In certain embodiments of the invention it is preferred that the Write Ticket not merely encode the Current Buffer Index, but also encode the Buffer Sequence Number of the current buffer. To understand why, consider a design where the detection of slow readers is left entirely to monitoring the Buffer Sequence Number contained within the buffers. Suppose that Reader A has just read the Write Ticket and determined the current buffer index to be X but is preempted before referencing buffer X. While Reader A is preempted, any manner of activity can take place, including the reuse of the buffer X by Writer B. If Reader A resumed execution after Writer B had incremented the buffer sequence number of buffer X but before it had completed updating the data within the buffer, Reader A would not observe a change in the buffer sequence number even though the data was in the process of being modified. By recording the expected value of the Buffer Sequence Number in the Write Ticket, any change to a buffer since it was released as the most recently written data can be detected by readers.

### Sequence Number Rollover

Sequence numbers are stored in the Buffer Sequence Number and encoded within the Write Ticket. These sequence numbers can rollover, depending on the size of the seq_t type. In this section, we discuss the implications of rollover and how rollover can be avoided by an appropriately large size of seq_t. In the following discussion, MAXSEQ-1 is the maximum sequence number that can be stored (or encoded) in the variable in question.

Buffer Sequence Number rollover, whether in the Write Ticket or in the buffers, introduces the possibility that a reader will not detect that writes have corrupted the buffer being read. The probability that a rollover will prevent this reader from detecting a buffer overwrite is exceedingly small, however, since the number of writes that must take place to escape detection must be an exact integral multiple of MAXSEQ.

Sequence number rollover can be avoided entirely be using a large seq_t type. For 64-bit seq_t types, MAXSEQ is approximately 16·10¹⁸. Assuming a write takes place every 1 microsecond, it would take approximately 5·10⁵ years of continuous operation for rollover to occur.

Sequence number rollover in the Write Ticket is more frequent since fewer bits are available to encode the sequence number and is therefore the limiting factor. But even if there were as many as 1,000 buffers in the pool of the data channel (requiring 10 of the 64 bits to encode), it would take approximately 500 years of continuous operation for rollover to occur.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of exchanging data between a reader and a writer on a computer system, the method comprising:
establishing a region of global shared memory, the memory comprising a plurality of discrete buffers and a write ticket, each buffer having an associated buffer sequence number and comprising a data area, and the write ticket encoding a current buffer index and the buffer sequence number of the current buffer;
assigning a subset of the buffers to a writer;
writing data to memory, where writing comprises, in sequence:
selecting a buffer from the subset of buffers;
incrementing the buffer sequence number of the selected buffer;
writing data to the selected buffer; and
atomically updating the current buffer index and buffer sequence number of the write ticket with identifying information for the selected buffer;
reading data from memory, where reading comprises, in sequence:
atomically reading the write ticket to obtain the current buffer index and buffer sequence number;
reading data from the buffer referred to by the obtained current buffer index;
atomically reading the buffer sequence number of the buffer referred to by the obtained current buffer index;
comparing the results of the read of the buffer sequence number of the buffer referred to by the obtained current buffer index with the buffer sequence number read from the obtained write ticket; and
if the compared results differ, restarting the reading step.

2. A method of exchanging data between a reader and a writer on a computer system, the method comprising:
establishing a region of global shared memory, the memory comprising a plurality of discrete buffers and a write ticket, each buffer comprising a buffer sequence number, a time stamp, and a data area, and the write ticket encoding a current buffer index and the buffer sequence number of the current buffer;
assigning a subset of the buffers to a writer;
writing data to memory, where writing comprises, in sequence:
selecting a buffer from the subset of buffers;
incrementing the buffer sequence number of the selected buffer;
writing data and a time stamp to the selected buffer;
atomically reading the write ticket to determine the current buffer;
comparing the time stamps of the current buffer and the selected buffer; and
if the time stamp of the selected buffer is not earlier than the current buffer, atomically updating the current buffer index and buffer sequence number of the write ticket to make the selected buffer the current buffer;
reading data from memory, where reading comprises, in sequence:
atomically reading the write ticket to obtain the current buffer index and buffer sequence number;
reading data from the buffer referred to by the current buffer index;
atomically reading the buffer sequence number of the buffer referred to by the current buffer index;
comparing the results of the read of the buffer sequence number of the buffer referred to by the current buffer index with the buffer sequence number read from the obtained write ticket; and
if the compared results differ, restarting the reading step.

3. The method of claim 1 or claim 2, wherein there is a plurality of writers on the computer system, and wherein assigning includes assigning each writer a distinct subset of buffers.

4. The method of claim 1 or claim 2, wherein there is a plurality of readers on the computer system.

5. The method of claim 4, wherein the readers run on the same processor.

6. The method of claim 4, wherein the readers run on different processors.

7. The method of claim 1 or claim 2, wherein selecting a buffer during writing comprises selecting the least recently used buffer from the writer's assigned buffers.

8. The method of claim 1 or claim 2, wherein the reader or the writer is selected from the group consisting of a general process, a thread of a general process, a kernel process, a thread of a kernel process, and an interrupt routine.

9. The method of claim 1 or claim 2, wherein the current buffer is the most recently written buffer.

10. A data exchange system for a computer, comprising:
at least one reader;
at least one writer; and
a region of global shared memory comprising a plurality of buffers and a write ticket, each buffer comprising a buffer sequence number and a data area,
wherein
each writer on the system has assigned to it a subset of the buffers;
each writer on the system writes to each of its buffers in sequence in successive write operations; and
each reader on the system reads buffers written by the writers by consulting the write ticket to determine which of a writer's buffers is the current buffer and to determine the expected buffer sequence number;
reading the current buffer;
after reading, consulting the buffer sequence number to determine whether the read buffer has been rewritten during reading; and
if the read buffer has been rewritten, initiating a new read operation.

11. The data exchange system of claim 9, wherein a plurality of readers exist on the system.

12. The data exchange system of claim 11, wherein the readers run on different processors.

13. The data exchange system of claim 11, wherein the readers run on the same processor.

14. The data exchange system of claim 9, wherein a plurality of writers exist on the system, and wherein the subset of the buffers assigned to each of the writers is distinct.

15. The data exchange system of claim 14, wherein the writers run on different processors.

16. The data exchange system of claim 14, wherein the writers run on the same processor.

17. The data exchange system of claim 9, wherein the reader or the writer is selected from the group consisting of a general process, a thread of a general process, a kernel process, a thread of a kernel process, and an interrupt routine.

18. The method of claim 3, wherein the writers run on the same processor.

19. The method of claim 3, wherein the writers run on different processors.

20. The method of claim 1 or claim 2, wherein selecting a buffer during writing comprises selecting any buffer except the most recently written buffer from the writer's assigned buffers.
